(19) United States
(12) Patent Application Publication
(10) Pub. No.: US 2014/0307006 A1
(43) Pub. Date: Oct. 16, 2014

(54) DISPLAY DEVICE

(71) Applicant: Funai Electric Co., Ltd., Osaka (JP)

(72) Inventor: Tatsuya Kita, Osaka (JP)

(73) Assignee: FUNAI ELECTRIC CO., LTD., Osaka (JP)

(21) Appl. No.: 14/245,337

(22) Filed: Apr. 4, 2014

(30) Foreign Application Priority Data
Apr. 12, 2013 (JP) 2013-084398

(51) Int. Cl. G09G 3/36

(52) U.S. Cl. CPC G09G 3/3648
USPC 345/690; 345/87

(57) ABSTRACT

A display device includes a display and a controller. The display includes a plurality of signal lines that transmits signals for controlling brightness values of a plurality of pixels configuring a display panel, and a drive circuit that applies a voltage to a plurality of scanning lines that transmits signals for switching between SELECT and DESELECT for each of the plurality of pixels. The controller generates a power source voltage for a signal line voltage to be applied to the plurality of signal lines.

### TECHNICAL FIELD

The present invention relates to a display device.

### BACKGROUND TECHNOLOGY

A display device of a liquid crystal display device or the like is generally provided with a display, which is provided with a display panel that displays images and a drive circuit thereof, and a controller that supplies a power source to the display. Moreover, the display and the controller are generally configured as separate units.

As an example of such a liquid crystal display device, there is disclosed a liquid crystal display provided with, for example, a liquid crystal display unit that performs display control of a liquid crystal panel (an example of the display panel) and a TV substrate unit configured as a separate unit from the liquid crystal display unit and that supplies the power source to the liquid crystal display unit (for example, see Patent Document 1).

The TV substrate unit of the liquid crystal display device described in the above Patent Document 1, in order to correspond to a plurality of types of liquid crystal display units, generates a plurality of power sources with varying voltage values and selectively supplies a plurality of power sources corresponding to the liquid crystal display unit to be connected.

### RELATED ART DOCUMENTS

### Patent Documents

[Patent Document 1] Japanese Unexamined Patent Application Publication No. H08-5986

However, further reduction in costs associated with manufacturing is sought for liquid crystal panels.

The display device described in the Patent Document 1 can increase versatility of the liquid crystal display unit by generating a plurality of types of power sources, but also results in increased component count and costs.

### SUMMARY OF THE INVENTION

One or more embodiments of the present invention provide a display device that can reduce costs associated with manufacturing.

One or more embodiments of the present invention display may comprise: a display comprising: a plurality of signal lines that transmits signals for controlling brightness values of a plurality of pixels configuring a display panel; and a drive circuit that applies a voltage to a plurality of scanning lines that transmits signals for switching between SELECT and DESELECT for each of the plurality of pixels; and a controller that generates a power source voltage for a signal line voltage to be applied to the plurality of signal lines.

As a result of this configuration, for example, a method to reduce costs associated with manufacturing, it is conceivable to reduce a component count in the circuitry.

In one or more embodiments, the display device may have a liquid crystal display unit (display) and a TV substrate unit (controller) configured as separate units, and these may be manufactured by different manufacturers. Because of this, a voltage of, for example, 12 V, 5 V, or the like is used as a standard voltage of a voltage to be supplied from the TV substrate unit (controller) to the liquid crystal display unit (display).

However, the voltage value of 12 V or 5 V differs from a voltage value of a voltage used to drive the display panel. Because of this, the conventional display generates the power source voltage or the like for the signal line voltage to be applied to the signal line of the display panel, and this is done by adjusting the voltage value of the voltage supplied from the controller using a DC/DC converter. For example, in the display device according to Patent Document 1, the display (signal side drive circuit) generates the voltage to be applied to the signal line (signal line) from the plurality of voltages generated in the controller. The voltage to be applied to the signal line is generally generated using the DC/DC converter.

In contrast, the controller according to one or more embodiments directly generates the power source voltage for the signal line voltage to be applied to the signal line of the display panel. The display according to one or more embodiments can thereby obtain the power source voltage for the signal line voltage without using the DC/DC converter. That is, in the display device of the above configuration, the display does not need the DC/DC converter. The display device of the above configuration can thereby reduce the component count and manufacturing costs.

In one or more embodiments, the controller may comprise an LED circuit that configures a backlight of the display panel and supplies the power source voltage for the signal line voltage to the LED circuit.

As a result, for example, there may be no need to provide a rectifier circuit that generates a voltage to supply to the LED circuit because the signal line voltage is supplied to the LED circuit, thereby enabling reduction of the component count.

In one or more embodiments, the display may further comprise a charge pump circuit that generates a scanning line voltage to be applied to the plurality of scanning lines using the power source voltage for the signal line voltage.

As a result, for example, manufacturing costs can be suppressed from increasing because the charge pump circuit alone usually generates the scanning line voltage, without using the DC/DC converter.

In one or more embodiments, the controller may generate a signal for compensating voltage variation in the display, and the display may use the signal for compensating voltage variation as a control signal for operation control of the charge pump circuit.

In one or more embodiments, the controller may output a pulse that is output from a DC/DC converter as the control signal for operation control of the charge pump circuit, and the display may use the pulse as the control signal for operation control of the charge pump circuit.

In one or more embodiments, the charge pump circuit may operate at a prefixed duty ratio.

In one or more embodiments, the display panel may be a liquid crystal panel that disposes the plurality of pixels in a matrix, connects each of the plurality of signal lines to the plurality of pixels disposed on the same row, and connects each of the plurality of scanning lines to the plurality of pixels disposed on the same column.

One or more embodiments of the present invention can provide a display device than can reduce costs associated with manufacturing.

### BRIEF DESCRIPTION OF DRAWINGS

FIG. 1 is a perspective view illustrating an example of an external appearance of a display device according to one or more embodiments.

FIG. 2 is a block diagram illustrating an example of a configuration of a display device according to one or more embodiments.

FIG. 3 is a block diagram illustrating an example of a configuration of a display device according to one or more embodiments.

### DETAILED DESCRIPTION OF EMBODIMENTS

Embodiments of the present invention will be described in detail below using drawings. Note that the figures do not necessarily strictly illustrate dimensions, dimension ratios, and the like.

Furthermore, each embodiment described below illustrates mere examples of the present invention. Numerical values, shapes, materials, components, disposed positions and connection modes of the components, steps, ordering of the steps, and the like illustrated in the embodiments below are but an example and not meant to limit the present invention. The present invention is specified by the scope of the patent claims. Therefore, among the components in the embodiments below, components not described in the independent claims are not necessarily needed to achieve the present invention but are described as configuring various embodiments of the present invention.

### Embodiments

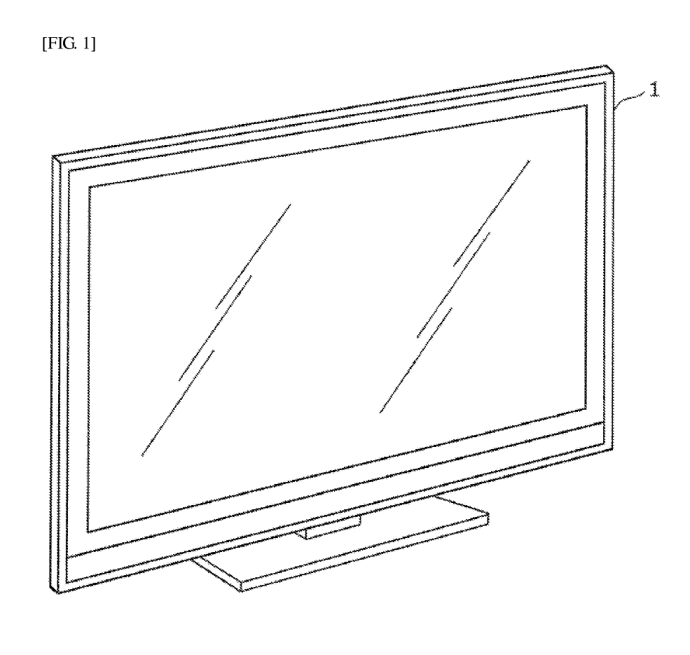

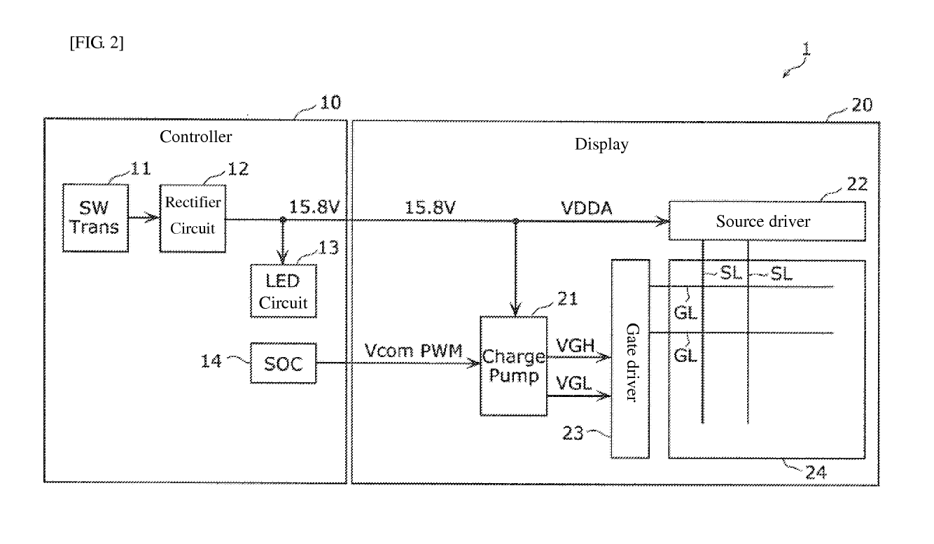

A display device according to the according to one or more embodiments will be described based on FIGS. 1 and 2.

In one or more embodiments, an example will be described where a display device is a liquid crystal display (LCD). FIG. 1 is a perspective view illustrating an example of an external appearance of a liquid crystal display 1.

[1-1. Configuration of the Display Device according to the One or More Embodiments]

The display device according to the present invention will be described based on FIG. 2. FIG. 2 is a block diagram illustrating a configuration of the display device according to one or more embodiments.

As described above, the display device is the liquid crystal display 1 and is provided with a display 20 that displays images on a display panel and a controller 10 that supplies voltage to the display 20, as illustrated in FIG. 2.

The display 20 is provided with a liquid crystal panel 24 as an example of the display panel and a drive circuit of the liquid crystal panel 24. The liquid crystal panel 24 is configured from a plate-like member with a substantially rectangular planar shape. The liquid crystal panel 24 is provided with a plurality of pixels disposed in a matrix, a plurality of signal lines SL, and a plurality of scanning lines GL. In one or more embodiments, the liquid crystal panel 24 is a liquid crystal panel 24 of an active matrix type, but the invention is not limited thereto. Moreover, the liquid crystal panel 24 is not an essential component in one or more embodiments the present invention.

Each pixel is configured from a plurality of subpixels of, for example, red (R), green (G), blue (B), or the like. Note that the subpixels are not limited to the three primary colors of RGB but may include other colors such as yellow (Y). While not illustrated, each subpixel is provided with, for example, a switching transistor (TFT) and a condenser. The switching transistor respectively connects a source terminal to the signal line SL, a gate terminal to the scanning line GL, and a drain terminal to an end of the condenser.

The signal line SL (data line) is wiring that transmits signals for controlling brightness values of the plurality of pixels and is provided to correspond with each column of the subpixels disposed in the matrix. That is, the signal line SL is connected to the source terminal of the switching transistor configuring the subpixels disposed in the corresponding columns. The brightness values can be controlled by controlling the voltage applied to the signal line SL.

The scanning line GL is wiring that transmits signals for switching between SELECT and DESELECT for each of the plurality of pixels and is provided to correspond with each row of the subpixels disposed in the matrix. That is, the scanning line GL is connected to the gate terminal of the switching transistor configuring the subpixels disposed in the corresponding rows. Switching between SELECT and DESELECT can be performed by controlling the voltage applied to the scanning line GL.

As illustrated in FIG. 2, the drive circuit is provided with a charge pump circuit 21, a source driver 22, and a gate driver 23. Note that the charge pump circuit 21 and the gate driver 23 are not essential components in one or more embodiments of the present invention.

The source driver 22 accepts a power source voltage VDDA for a signal line voltage supplied from the controller 10 and generates a voltage corresponding to each brightness value. The source driver 22 applies the voltage corresponding to the brightness value indicated by the data signal to each of the plurality of signal lines SL. Here, a voltage value of the power source voltage VDDA is a maximum value (a voltage value at a maximum brightness value) of the voltage applied to the signal line SL. The source driver 22 divides the power source voltage VDDA by a resistive divider and generates the voltage corresponding to each brightness value. That is, the source driver 22 generates the voltage corresponding to each brightness value from the power source voltage VDDA without DC/DC converting the power source voltage VDDA supplied form the controller 10.

The charge pump circuit 21 uses the power source voltage VDDA supplied from the controller 10 to generate a voltage VGH for turning the subpixels on and a voltage VGL for turning the subpixels off. In one or more embodiments, a Vcom PWM signal, which will be described below, that is output from the controller 10 is used as a control signal.

Note that the Vcom PWM signal is a signal conventionally used to compensate for voltage variation of a common voltage Vcom applied to a common electrode (transparent electrode) of the liquid crystal panel 24. The common voltage Vcom may be, for example, 7 to 8 V. The display 20 adjusts a voltage value of the common voltage Vcom according to a duty ratio of the Vcom PWM signal, which is not illustrated. Using the Vcom PWM signal as the control signal of the charge pump circuit 21 enables control of the charge pump circuit 21 without increasing a pin count. Moreover, a configuration of the controller 10 can be suppressed from becoming complex. The voltage VGH is, for example, 30 V. The voltage VGL is, for example, −8 V.

Note that a smooth condenser with a large capacity, for example, may be provided if a frequency of the Vcom PWM signal is low.

The gate driver 23 is applied to the scanning line GL described above using the voltages VGH and VGL output from the charge pump circuit 21.

The controller 10 generates the signal line voltage applied to the plurality of signal lines SL using an external power source. As illustrated in FIG. 2, one or more embodiments are provided with a trans circuit 11, a rectifier circuit 12, an LED circuit 13, and a system on chip (SOC) circuit 14. Note that the trans circuit 11, the LED circuit 13, and the SOC circuit 14 are not essential components in one or more embodiments of the present invention.

The trans circuit 11 is a transformer circuit that adjusts a voltage of the external power source.

In one or more embodiments, the rectifier circuit 12 generates and outputs to the display 20 the power source voltage VDDA for the signal line voltage applied to the signal line SL of the liquid crystal panel 24 from the voltage output from the trans circuit 11. Note that the power source voltage VDDA in one or more embodiments is 15.8 V.

The LED circuit 13 is provided with a backlight for the display panel and operates (lights) by application of the power source voltage VDDA.

The SOC circuit 14 is a circuit that generates a control signal for controlling each circuit configuring the controller 10 and the display 20. The SOC circuit 14 according to one or more embodiments outputs the Vcom PWM signal for compensating for voltage variation to the display 20.

[1-2. Configuration of Comparative Example and Comparison of the Comparative Example and the Display Device according to One or More Embodiments]

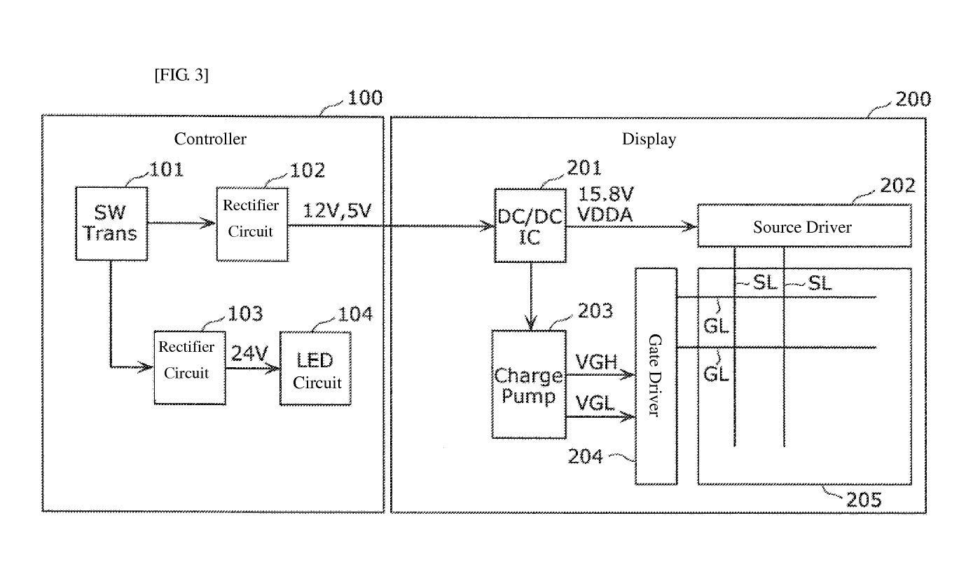

FIG. 3 is a block diagram illustrating an example of a configuration of a display device 2 according to a comparative example. The display device 2 is provided with a display 200 that displays images on a display panel and a controller 100 that supplies voltage to the display 200.

The display 200 illustrated in FIG. 3 is provided with a liquid crystal panel 205 as an example of the display panel and a drive circuit of the liquid crystal panel 205. A configuration of the liquid crystal panel 205 illustrated in FIG. 3 is the same as the configuration of the liquid crystal panel of one or more embodiments.

The drive circuit is provided with a DC/DC converter 201, a source driver 202, a charge pump circuit 203, and a gate driver 204. The DC/DC converter 201 converts a voltage of 12 V or 5 V supplied from a controller 100 to a power source voltage VDDA for a signal line voltage to be applied to a signal line SL. The source driver 202 applies the power source voltage VDDA output from the DC/DC converter 201 to the signal line SL. The charge pump circuit 203 uses the voltage output from the DC/DC converter 201 to generate a voltage VGH and a voltage VGL to be applied to a scanning line GL. The gate driver 204 applies the voltages VGH and VGL output from the charge pump circuit 203 to the scanning line GL described above.

The controller 100 is provided with a trans circuit 101, rectifier circuits 102 and 103, and an LED circuit 104.

The trans circuit 101 is a transformer circuit that adjusts a voltage of an external power source.

The rectifier circuit 102 uses a voltage output from the trans circuit 101 to generate and supply to the display 200 a voltage of 12 V or 5 V. Note that generally the controller 100 and the display 200 are configured as separate units and that these are combined to assemble the display device. Because of this, the voltage of 12 V or 5 V is used as the industry standard voltage value.

The rectifier circuit 103 generates a voltage to be supplied to the LED circuit 104, here, 24 V. The LED circuit 104 is a backlight of the liquid crystal panel 205.

As illustrated in FIG. 3, because the rectifier circuit 102 in the controller 100 according to the comparative example outputs the voltage of 12 V or 5 V, the display 200 needs to use this voltage of 12 V or 5 V to generate the power source voltage VDDA using the DC/DC converter 201.

In contrast, the rectifier circuit of the controller 10 in the display device of one or more embodiments generates the power source voltage VDDA for the signal line voltage to be applied to the signal line SL of the liquid crystal panel. Because of this, the display of the display device according to one or more embodiments does not need to generate the power source voltage VDDA and does not need to be provided with the DC/DC converter 201. That is, it becomes possible to reduce a component count and suppress costs associated with manufacturing.

(Modifications and the Like of the Embodiments)

The display device relating to one or more embodiments of the present invention are described above, but the present invention is not limited to these embodiments.

(1) In one or more embodiments described above, an example where the display device is the liquid crystal display 1 is described, but the display device may be another display device such as an organic electro-luminescence (Organic EL) display or the like. Note that if the display device is the organic EL display, the display panel is an organic EL panel.

(2) One or more embodiments described above use the Vcom PWM signal as the control signal for the charge pump circuit but are not limited thereto.

The charge pump circuit may operate at a fixed duty ratio such as 50% or the like. If at 50%, the charge pump circuit has favorable operation efficiency.

A DC/DC pulse output from the DC/DC converter provided to the controller may be used as the control signal for the charge pump circuit. Generally, because the controller is provided with the DC/DC converter, using the pulse from the DC/DC converter can suppress the configuration of the controller from becoming complex.

Furthermore, the SOC circuit of the controller may be configured so as to generate a dedicated control signal. In this case, it becomes possible to flexibly and finely control the charge pump circuit.

The display device according to one or more embodiments of the present invention is applicable, for example, as a display device of a liquid crystal display, an organic EL display, or the like. Although the disclosure has been described with respect to only a limited number of embodiments, those skilled in the art, having benefit of this disclosure, will appreciate that various other embodiments may be devised without departing from the scope of the present invention. Accordingly, the scope of the present invention should be limited only by the attached claims.

### Explanation of Reference Numerals

1 Liquid crystal display
10 Controller
11 Trans circuit
12 Rectifier circuit
13 LED circuit
14 SOC circuit
20 Display
21 Charge pump circuit
22 Source driver
23 Gate driver
24 Liquid crystal panel
100 Controller
101 Trans circuit
102 Rectifier circuit
103 Rectifier circuit
104 LED circuit
200 Display
201 DC/DC converter
202 Source driver
203 Charge pump circuit
204 Gate driver
205 Liquid crystal panel
SL Signal line
GL Scanning line

1. A display device, comprising:
a display comprising:
a plurality of signal lines that transmits signals for controlling brightness values of a plurality of pixels configuring a display panel; and
a drive circuit that applies a voltage to a plurality of scanning lines that transmits signals for switching between SELECT and DESELECT for each of the plurality of pixels; and
a controller that generates a power source voltage for a signal line voltage to be applied to the plurality of signal lines.

2. The display device according to claim 1, wherein
the controller comprises an LED circuit that configures a backlight of the display panel and supplies the power source voltage for the signal line voltage to the LED circuit.

3. The display device according to claim 1, wherein
the display further comprises a charge pump circuit that generates a scanning line voltage to be applied to the plurality of scanning lines using the power source voltage for the signal line voltage.

4. The display device according to claim 3, wherein
the controller generates a signal for compensating voltage variation in the display, and
the display uses the signal for compensating voltage variation as a control signal for operation control of the charge pump circuit.

5. The display device according to claim 3, wherein
the controller outputs a pulse that is output from a DC/DC converter as the control signal for operation control of the charge pump circuit, and
the display uses the pulse as the control signal for operation control of the charge pump circuit.

6. The display device according to claim 3, wherein
the charge pump circuit operates at a prefixed duty ratio.

7. The display device according to claim 1, wherein
the display panel is a liquid crystal panel that disposes the plurality of pixels in a matrix, connects each of the plurality of signal lines to the plurality of pixels disposed on the same row, and connects each of the plurality of scanning lines to the plurality of pixels disposed on the same column.

8. A display device controlling method comprising:
transmitting signals from a plurality of signal lines for controlling brightness values of a plurality of pixels configuring a display panel;
applying a voltage to a plurality of scanning lines that transmits signals for switching between SELECT and DESELECT for each of the plurality of pixels; and
generating a power source voltage for a signal line voltage to be applied to the plurality of signal lines.

9. The display device controlling method according to claim 8, further comprising:
configuring a backlight of the display panel and supplying the power source voltage for the signal line voltage to the LED circuit.

10. The display device controlling method according to claim 1, further comprising:
generating a scanning line voltage to be applied to the plurality of scanning lines using the power source voltage for the signal line voltage.

11. The display device controlling method according to claim 3, further comprising:
generating a signal for compensating voltage variation in the display, and
using the signal for compensating voltage variation as a control signal for operation control of a charge pump circuit that generates the scanning line voltage.

12. The display device controlling method according to claim 3, further comprising:
outputting a pulse that is output from a DC/DC converter as the control signal for operation control of the charge pump circuit, and
using the pulse as a control signal for operation control of a charge pump circuit that generates the scanning line voltage.

13. The display device controlling method according to claim 3, further comprising:
operating a charge pump circuit that generates the scanning line voltage at a prefixed duty ratio.

14. The display device controlling method according to claim 1, wherein
the display panel is a liquid crystal panel that disposes the plurality of pixels in a matrix, connects each of the plurality of signal lines to the plurality of pixels disposed on the same row, and connects each of the plurality of scanning lines to the plurality of pixels disposed on the same column.

15. The display device according to claim 2, wherein
the display further comprises a charge pump circuit that generates a scanning line voltage to be applied to the plurality of scanning lines using the power source voltage for the signal line voltage.

16. The display device according to claim 2, wherein
the display panel is a liquid crystal panel that disposes the plurality of pixels in a matrix, connects each of the plurality of signal lines to the plurality of pixels disposed on the same row, and connects each of the plurality of scanning lines to the plurality of pixels disposed on the same column.

17. The display device according to claim 3, wherein
the display panel is a liquid crystal panel that disposes the plurality of pixels in a matrix, connects each of the plurality of signal lines to the plurality of pixels disposed on the same row, and connects each of the plurality of scanning lines to the plurality of pixels disposed on the same column.

18. The display device according to claim 4, wherein
the display panel is a liquid crystal panel that disposes the plurality of pixels in a matrix, connects each of the plurality of signal lines to the plurality of pixels disposed on the same row, and connects each of the plurality of scanning lines to the plurality of pixels disposed on the same column.

19. The display device according to claim 5, wherein
the display panel is a liquid crystal panel that disposes the plurality of pixels in a matrix, connects each of the plurality of signal lines to the plurality of pixels disposed on the same row, and connects each of the plurality of scanning lines to the plurality of pixels disposed on the same column.

20. The display device according to claim 6, wherein
the display panel is a liquid crystal panel that disposes the plurality of pixels in a matrix, connects each of the plurality of signal lines to the plurality of pixels disposed on the same row, and connects each of the plurality of scanning lines to the plurality of pixels disposed on the same column.
